(19) United States
(12) Patent Application Publication
(10) Pub. No.: US 2024/0020319 A1
(43) Pub. Date: Jan. 18, 2024

(54) FEEDBACK COLLECTIONS BASED ON TOPICS OF INTEREST

(71) Applicant: Hewlett-Packard Development Company, L.P., Spring, TX (US)

(72) Inventor: Rafael DAL ZOTTO, Porto Alegre (BR)

(73) Assignee: Hewlett-Packard Development Company, L.P., Spring, TX (US)

(21) Appl. No.: 17/866,099

(22) Filed: Jul. 15, 2022

(51) Int. Cl. G06F 16/28

(52) U.S. Cl. CPC G06F 16/285

(57) ABSTRACT

According to examples, an apparatus may include a processor and a memory on which are stored machine-readable instructions that, when executed by the processor, may cause the processor to receive a first feedback from a first device in response to a first question. The processor may determine a first topic and a first sentiment based on the first feedback. The first feedback may be correlated to the first device. The processor may identify a second device having a characteristic that is the same as a characteristic of the first device and may generate a second question based on the determined first topic. The processor may validate the determined first sentiment based on a second feedback from the second device responsive to the second question. The processor may output information regarding the validation of the determined first sentiment.

### BACKGROUND

Computing devices may collect various types of feedback from users regarding devices and/or services. The feedback may be associated with certain topics and may include user sentiments regarding the devices and/or services, which may indicate potential issues with the devices and/or services.

### BRIEF DESCRIPTION OF THE DRAWINGS

Features of the present disclosure are illustrated by way of example and not limited in the following figure(s), in which like numerals indicate like elements, in which:

FIG. 1 depicts a block diagram of an example apparatus that may determine a topic and a first sentiment based on a first feedback from a first device and validate the determined first sentiment based on a second feedback responsive to a second question from a second device;

FIG. 2 depicts a block diagram of an example system within which the example apparatus depicted in FIG. 1 may be implemented;

FIG. 3 depicts a diagram of example feedback collection user interfaces to collect feedback from users at devices;

FIG. 4 depicts a flow diagram of an example process for extracting content from received feedback to update a feedback knowledge base;

FIG. 5 depicts a diagram of an example schema of a feedback knowledge base, which may store the extracted content depicted in FIG. 4;

FIG. 6 depicts a block diagram of example groupings of similar devices based on characteristics of the devices;

FIG. 7 depicts a flow diagram of an example process for triggering collection of additional feedback from similar devices based on receipt of feedback;

FIG. 8 depicts a flow diagram of an example method for determining a topic and a first sentiment based on a first feedback received from a first device, and validating the first feedback based on a second feedback from a second device; and

FIG. 9 depicts a block diagram of an example computer-readable medium that may have stored thereon computer-readable instructions to determine whether a first sentiment and/or a topic in a first feedback are of interest, and based on a determination that the first sentiment and/or the topic are of interest, to collect a second feedback from a second device that is similar to the first device to validate the first sentiment in the first feedback.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Generally, users may provide various types of feedback regarding their devices and/or software executed on their devices. The feedback may be based on a variety of questions posed to the users regarding their experience with the devices and/or software. The feedback may pertain to various aspects of the devices, such as hardware and/or software features of the devices, and the user's experiences while using the devices. In some instances, the feedback, particularly negative feedback, may be used to identify potential issues with the devices.

A concern with processing collected feedback may be that some users and their feedback may be biased, for instance, affected by “confirmation bias.” Confirmation bias as defined in the present disclosure may be a tendency to search for, interpret, favor, and/or recall information in a way that may confirm or support one's prior beliefs or values. As such, the collected feedback may be analyzed to identify feedback that may be affected by confirmation bias. Identification of the feedback that may suffer from confirmation bias may be used to improve reliability of the information contained in the feedback. However, in some instances, it may be difficult to identify whether a particular feedback is affected by confirmation bias. For instance, a negative feedback from a user about a certain topic may be a result of confirmation bias. A second occurrence of a negative feedback for the same topic from a different device may confirm the negative feedback. However, unless the second user submits a feedback, the second occurrence of the negative user experience may be not taken into account. In some instances, an administrator may manually validate a particular negative feedback by contacting the user that submitted the negative feedback to obtain additional information regarding their experiences, which may clarify any confirmation bias issues. In these instances, the validation of the negative feedback may be difficult and time consuming, which in turn may delay identification of potential issues with the devices.

Disclosed herein are apparatuses, systems, methods, and computer-readable media that may enable efficient collection and validation of feedback received from devices. In some examples, a processor may receive a first feedback from a first device in response to a first question. The processor may determine a topic and a sentiment based on the first feedback, and may identify a second device, or a group of devices, that may be similar to the first device. In some examples, the processor may identify the second device based on a common characteristic between the first device and the second device, such as a device type, a model type, a device family, an installed accessory, hardware characteristics, software characteristics, and/or the like. The processor may generate a second question to send to the second device, and based on a second feedback received from the second device, the processor may validate the first feedback, for instance, based on whether a sentiment in the second feedback matches the first sentiment in the first feedback. The second question may be based on the determined topic based on the first feedback. In some examples, the processor may identify a plurality of topics and correlated sentiments based on the first feedback, and may generate one or more than one second question based on the plurality of topics. The processor may output information regarding the validation of the first feedback.

Through implementation of the features of the present disclosure, in which collected feedback may be confirmed or verified, negative and/or positive sentiments in a feedback may relatively more quickly be identified and validated, which in turn may allow, for instance, for faster resolution of trouble tickets and identification of root problems associated with the feedback. In some examples, sentiments correlated to certain topics may be validated to remove confirmation bias, and to determine whether certain issues are specific to a certain device or user, or whether the issues may apply to a wider group of devices, which in turn may enable relatively faster resolution of the issues, in some cases for large groups of devices.

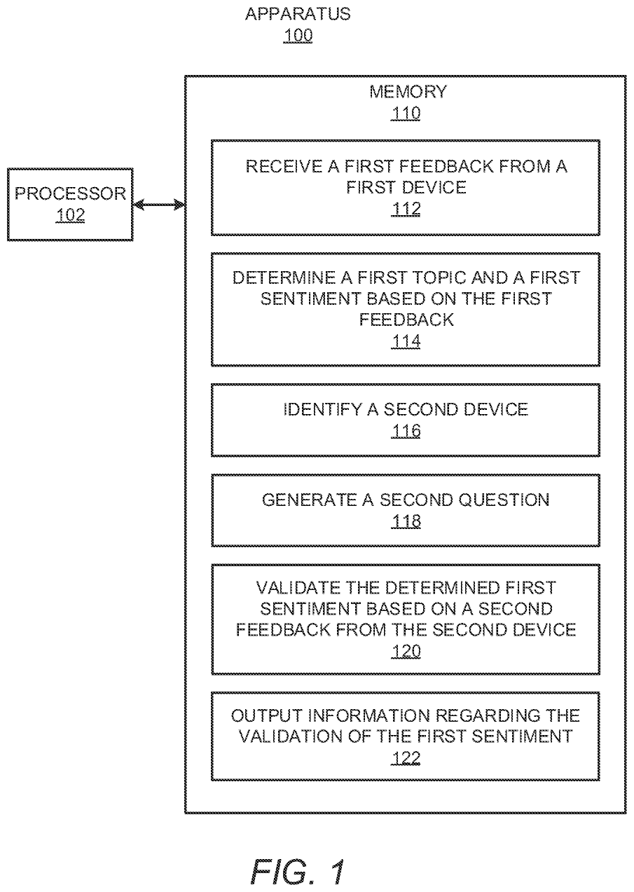

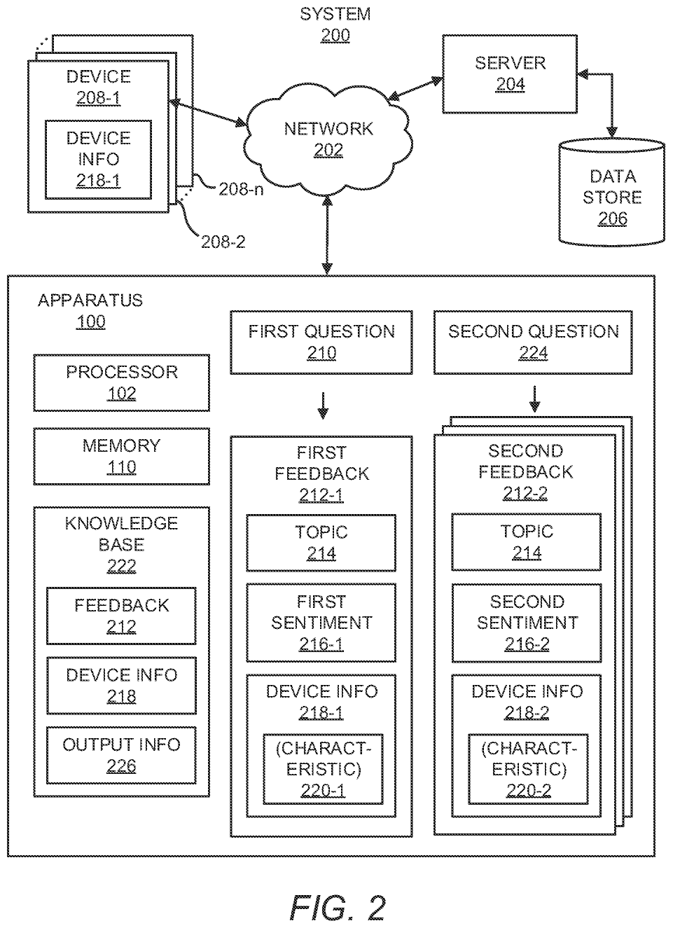

Reference is made to FIGS. 1-7. FIG. 1 depicts a block diagram of an example apparatus 100 that may determine a topic 214 and a first sentiment 216-1 based on a first feedback 212-1 from a first device 208-1 and validate the determined first sentiment 216-1 based on a second feedback 212-2 responsive to a second question 224 from a second device 208-2. FIG. 2 depicts a block diagram of an example system 200 within which the example apparatus 100 depicted in FIG. 1 may be implemented.

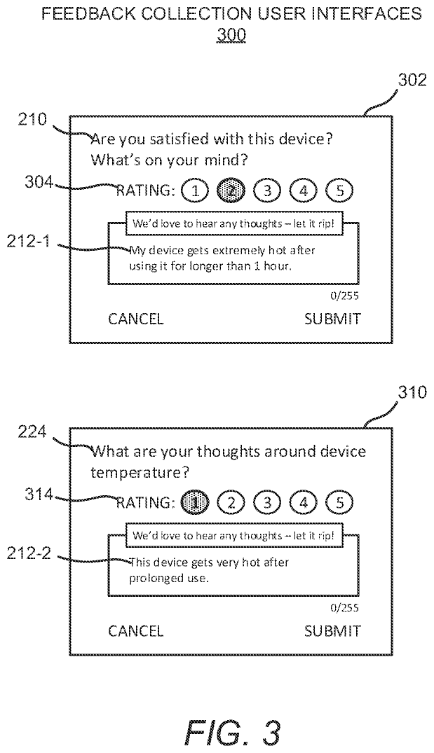

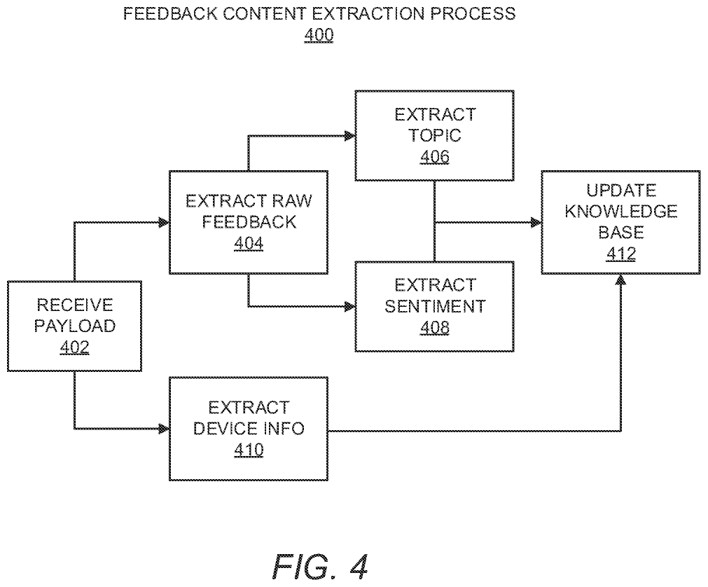

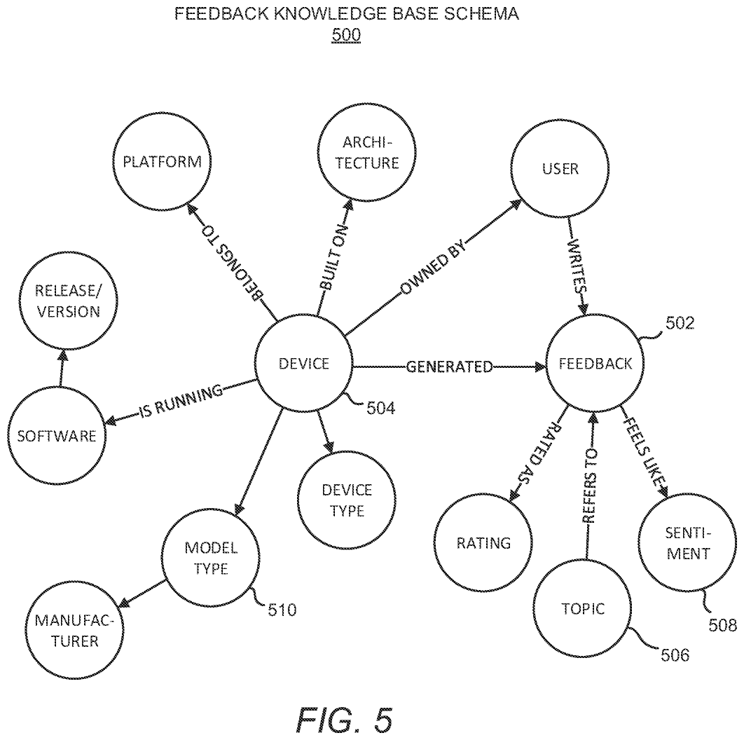

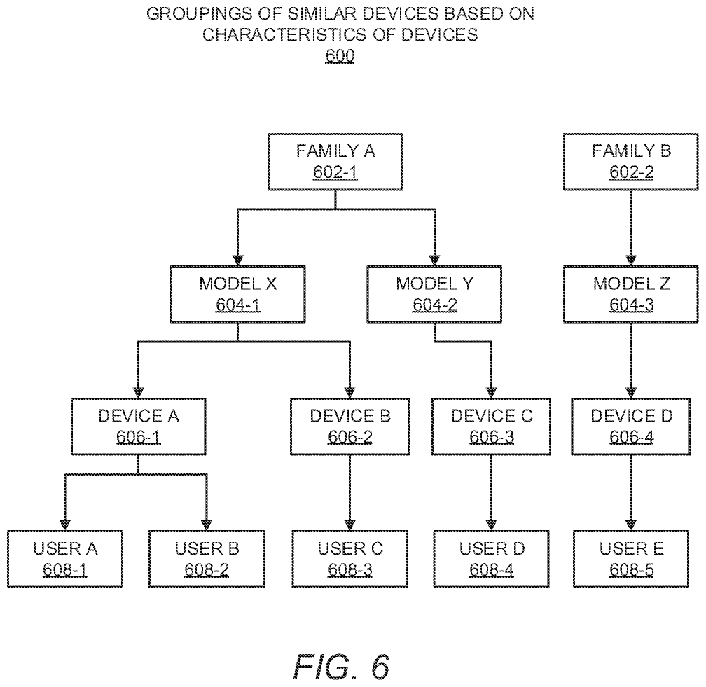

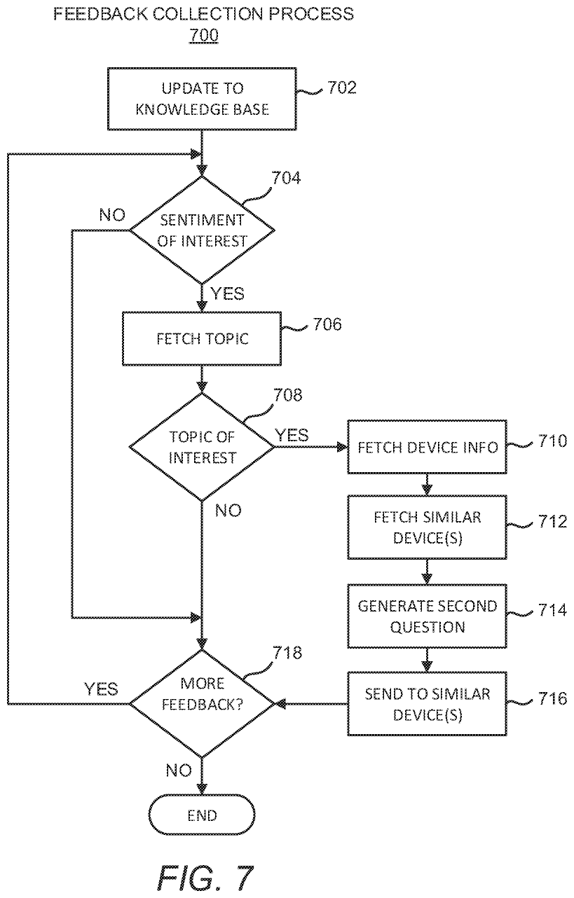

FIG. 3 depicts a diagram of example feedback collection user interfaces 300 to collect feedback 212 from users at devices 208. FIG. 4 depicts a flow diagram of an example process 400 for extracting content from received feedback 212 to update a feedback knowledge base 222. FIG. 5 depicts a diagram of an example schema 500 of the feedback knowledge base 222, which may store the extracted content depicted in FIG. 4. FIG. 6 depicts a block diagram of example groupings of similar devices 600 based on characteristics 220 of the devices 208. FIG. 7 depicts a flow diagram of an example process 700 for triggering collection of additional feedback 212 from similar devices 208 based on receipt of feedback 212.

It should be understood that the example apparatus 100 depicted in FIG. 1, the example system 200 depicted in FIG. 2, the example feedback collection user interfaces 300 depicted in FIG. 3, the example feedback content extraction process 400 depicted in FIG. 4, the example schema 500 depicted in FIG. 5, the example groupings of similar devices 600 depicted in FIG. 6, and the example feedback collection process 700 depicted in FIG. 7 may include additional features and that some of the features described herein may be removed and/or modified without departing from the scopes of the apparatus 100, the system 200, the user interfaces 300, the process 400, the schema 500, the similar devices 600, and/or the process 700.

The apparatus 100 may include a processor 102 and a memory 110. The apparatus 100 may be a computing device, including a server, a node in a network (such as a data center or a cloud computing resource), a desktop computer, a laptop computer, a tablet computer, a smartphone, an electronic device such as Internet of Things (IoT) device, and/or the like. The processor 102 may include a semiconductor-based microprocessor, a central processing unit (CPU), an application-specific integrated circuit (ASIC), a field-programmable gate array (FPGA), and/or other hardware device. In some examples, the apparatus 100 may include multiple processors and/or cores without departing from a scope of the apparatus. In this regard, references to a single processor as well as to a single memory may be understood to additionally or alternatively pertain to multiple processors and multiple memories.

The memory 110 may be an electronic, magnetic, optical, or other physical storage device that contains or stores executable instructions. The memory 110 may be, for example, Read Only Memory (ROM), flash memory, solid state drive, Random Access memory (RAM), an Electrically Erasable Programmable Read-Only Memory (EEPROM), a storage device, an optical disc, or the like. The memory 110 may be a non-transitory computer-readable medium. The term “non-transitory” does not encompass transitory propagating signals.

As shown in FIG. 1, the processor 102 may execute instructions 112-122 to validate feedback. The instructions 112-122 may be machine-readable instructions, e.g., non-transitory computer-readable instructions. In other examples, the apparatus 100 may include hardware logic blocks or a combination of instructions and hardware logic blocks to implement or execute functions corresponding to the instructions 112-122.

The apparatus 100 may be connected via a network 202, which may be the Internet, a local area network, and/or the like, to a server 204. In addition, a data store 206 may be connected to the server 204. A plurality of devices 208 may also be connected to the apparatus 100 and the server 204 via the network 202.

The processor 102 may fetch, decode, and execute the instructions 112 to receive a first feedback 212-1 from a first device 208-1 in response to a first question 210. The first feedback 212-1 may include a topic 214, a first sentiment 216-1 correlated to the topic 214, and device information 218-1 of the first device 208-1.

In some examples, the processor 102 may cause feedback collection user interfaces (UI) 300 depicted in FIG. 3 to be displayed at the devices 208 to collect the feedback 212 from the devices 208. By way of particular example and for purposes of illustration, the processor 102 may cause a first UI 302 to be displayed at the first device 208-1. The first UI 302 may present a predefined question, such as the first question 210, to the user at the first device 208-1. The user may submit the first feedback 212-1 via the first UI 302. In some examples, the first feedback 212-1 may include a text and/or a rating 304, such as a numerical rating “2” in this particular example. The first UI 302 may collect the first feedback 212-1, including the device information 218-1, at the first device 208-1 and may send the first feedback 212-1 to the processor 102. In some examples, the processor 102 may cause different ones of the UIs 300 to be displayed at respective ones of the devices 208. Alternatively or additionally, an application programming interface (API) installed at the devices 208 may manage the UIs 300. In some examples, the processor 102 may control access and usage of the API.

The processor 102 may fetch, decode, and execute the instructions 114 to determine the topic 214 and first sentiment 216-1 based on the received first feedback 212-1. At block 402 as depicted in FIG. 4, in some examples, the processor 102 may receive a payload for the first feedback 212-1 from the first device 208-1. At block 404, the processor 102 extract raw feedback data from the received payload, which may include the text of the first feedback 212-1. The processor 102 may extract the topic 214 correlated to the first feedback 212-1, at block 406, and may extract the first sentiment 216-1, at block 408. In some examples, the processor 102 may determine one or more than one topic 214 and a first sentiment 216-1 correlated to each of the one or more than one topic 214.

Continuing with the particular example in which the first feedback 212-1 is entered via the first UI 302, the processor 102 may extract the topic 214 and the first sentiment 216-1 based on the text of the first feedback 212-1. In some examples, the processor 102 may apply various types of processing, such as natural language processing (NLP), to determine the topic 214 and the first sentiment 216-1 from the text of the first feedback 212-1. In some examples, the topic 214 and the first sentiment 216-1 may be selected among a predefined set of topics and sentiments. Continuing with this particular example, the processor 102 may determine that the topic 214 is “temperature” and that the first sentiment 216-1 is “negative.” In some examples, the processor 102 may determine the first sentiment 216-1 based on a rating 304 correlated with the first feedback 212-1, for instance, based on predefined threshold values correlated to different sentiments, such as for negative, neutral, positive, or the like. In some examples, the processor 102 may determine the first sentiment 216-1 based only on the extracted text, or based on a combination of the rating 304 and the extracted text.

At block 410, the processor 102 may extract the device information 218-1 for the first device 208-1 from the received payload. The first feedback 212-1 may be correlated to the first device 208-1 and/or a user at the first device 208-1. The received payload for the first feedback 212-1 may include the device information 218-1 for the first device 208-1. The device information 218-1 may include various types of characteristics 220 of the first device 208-1, including a user at the first device 208-1, such as a user name, a user identifier, or the like, a unique identifier of the first device 208-1, a model type, a device type, a device family, an installed accessory, a hardware characteristic, a software characteristic, and/or the like.

At block 412, the processor 102 may update a knowledge base 222 to store the information that is extracted for the first feedback 212-1. In some examples, the processor 102 may store the extracted information as metadata into the knowledge base 222. The knowledge base 222 may include the received feedback 212, which may include the first feedback 212-1, and device information 218 correlated the received feedback 212, which may include the extracted device information 218-1.

Referring to FIG. 5, in some examples, the knowledge base 222 may have a predefined feedback knowledge base schema 500. The processor 102 may update the feedback knowledge base schema 500 to store the metadata correlated with the first feedback 212-1 and the first device 208-1. The feedback knowledge base schema 500 may be node-based, in which each node may correlate to a certain one of the characteristics 220-1 correlated to the first feedback 212-1. In some examples, the processor 102 may store a relationship between the various characteristics 220 correlated to the different nodes. For instance, the feedback node 502 may be related to the device node 504, which in turn may be related to a model type node 510, and so on. For instance, the processor 102 may store the topic 214 in the topic node 506 and the first sentiment 216-1 in the sentiment node 508. In some examples, the processor 102 may process the raw feedback data and store the extracted information in the knowledge base 222. The processor 102 determine the topic 214 and the first sentiment 216-1 for the received first feedback 212-1 based on the information stored in the knowledge base 222. It should be understood that the feedback knowledge base schema 500 may include different types and numbers of nodes, which may be correlated to different characteristics 220 than those shown in FIG. 5, for instance to cover different telemetry aspects. By way of particular example, the feedback knowledge base schema 500 may include an “application” node to list installed and/or in use applications.

The processor 102 may fetch, decode, and execute the instructions 116 to identify a second device 208-2 having a characteristic 220-2 that may be the same as, or similar to, the characteristic 220-1 of the first device 208-1. Referring to FIG. 6, by way of particular example and for purposes of illustration, the processor 102 may identify groupings of similar devices 600 based on four different types of characteristics, including a device family, a model type, a device identifier, and users. For instance, the group “FAMILY A” 602-1 may be a group of three devices that belong to the same or similar family type as the first device 208-1, which may include the “DEVICE A” 606-1, the “DEVICE B” 606-2, and the “DEVICE C” 606-3, and the group “MODEL X” 604-1 may be a group of devices that may share the same or similar model type as the first device 208-1, which includes the “Device A” 606-1 and the “Device B” 606-2, and so on. It should be understood that, while the example groupings of similar devices 600 as depicted in FIG. 6 are shown to include a limited number of characteristics 220 in order to facilitate description, namely device family, model type, device identifier, and users, the groupings of similar devices 600 may be based on various types and numbers of the characteristics 220 of the devices 208.

The processor 102 may fetch, decode, and execute the instructions 118 to generate a second question 224 based on the determined topic 214. In some examples, the processor 102 may generate the second question 224 based on the determined topic 214, first sentiment 216-1, the rating 304, the characteristic 220-1 of the first device 208-1, the characteristic 220-2 of the second device 208-2, or a combination thereof. In some examples, the processor 102 may omit the first sentiment 216-1 in the second question 224, for instance, to avoid causing potential bias or to otherwise influence the feedback 212. In some examples, the processor 102 may generate more than one second question 224 based on the determined topic 214 extracted from the first feedback 212-1. In some examples, the processor 102 may identify a plurality of topics 214 and a sentiment 216 correlated to respective ones of the identified plurality of topics 214 based on the first feedback 212-1, and may generate one or more than one second question 224 based on the plurality of topics 214.

In some examples, the processor 102 may identify a plurality of groups of similar devices 208. By way of particular example, the processor 102 may identify a first group of devices that belongs to the same family of devices as the first device 208-1 and a second group of devices that has the same model processor as the first device 208-1. In some examples, the processor 102 may generate the same question, such as the second question 224, for both groups, or may generate different questions, such as different ones of the second question 224, for each of the different groups of devices 208.

Continuing with the particular example in which the topic 214 of the first feedback 212-1 is the “temperature” at the first device 208-1, the processor 102 may cause a second UI 310 to be displayed at the second device 208-2 to present the second question 224 related to the topic 214, “temperature.” In this particular example, the processor 102 may send the second question 224 to the first group of devices that belongs to the same or a similar family as the first device 208-1 and the second group of devices that has the same or similar model processor as the first device 208-1.

The processor 102 may fetch, decode, and execute the instructions 120 to validate the determined first sentiment 216-1 based on a second feedback 212-2 from the second device 208-2 responsive to the second question 224. In some examples, the processor 102 may receive the second feedback 212-2 from the second device 208-2 and may determine a second sentiment 216-2 correlated to the determined topic 214 based on the second feedback 212-2. The processor 102 may determine the second sentiment 216-2 in the same manner in which the processor 102 determined the first sentiment 216-1. In some examples, the processor 102 may update the knowledge base 222 to include the information extracted from the second feedback 212-2, for instance, the second sentiment 216-2 and the device information 218-2 correlated with the second device 208-2.

The processor 102 may determine whether the second sentiment 216-2 from the second device 208-2 correlates to the determined first sentiment 216-1 from the first device 208-1. Based on a determination that the second sentiment 216-2 from the second device 208-2 correlates to the determined first sentiment 216-1 from the first device 208-1, the processor 102 may validate the determined first sentiment 216-1 correlated to the determined topic 214 from the first device 208-1.

In some examples, the processor 102 may determine the second sentiment 216-2 for the determined topic 214 correlated to the second device 208-2 based on the second feedback 212-2. The processor 102 may determine whether the determined second sentiment 216-2 correlated to the second device 208-2 is the same as or similar to the determined first sentiment 216-1 correlated to the first device 208-1. Based on a determination that the determined second sentiment 216-2 is the same as or similar to the determined first sentiment 216-1, the processor 102 may validate the determined first sentiment 216-1 for the determined topic 214 for the first device 208-1. In some examples, based on the determination that the determined second sentiment 216-2 is the same as or similar to the determined first sentiment 216-1, the processor 102 may validate the determined first sentiment 216-1 and may correlate the determined first sentiment 216-1 to a plurality of devices 208 having a characteristic 220 that is the same as or similar to the characteristic 220-1 of the first device 208-1 and the characteristic 220-2 of the second device 208-2.

Continuing with the particular example in which the topic 214 for the first feedback 212-1 is excessive temperature, based on a determination that the second sentiment 216-2 from the second device 208-2 may be the same as or similar to the first sentiment 216-1, the processor 102 may confirm that the first sentiment 216-1 is valid and may update the knowledge base 222 to include the information related to the validation.

In some examples, based on the determination that the second sentiment 216-2 from the second device 208-2 correlates to the determined first sentiment 216-1 from the first device 208-1, the processor 102 may validate the determined first sentiment 216-1 as being correlated to the determined topic 214 for a certain group of devices 208. For instance, the processor 102 may determine that the first sentiment 216-1 for the topic 214 may correlate to a user at the first device 208-1, a unique identifier of the first device 208-1, a model type of the first device 208-1, a device type of the first device 208-1, a device family of the first device 208-1, an installed accessory of the first device 208-1, a hardware characteristic of the first device 208-1, a software characteristic of the first device 208-1, or a combination thereof.

Continuing with the particular example in in which the topic 214 for the first feedback 212-1 is excessive temperature, the processor 102 may send the second question 224 to a second device 208-2, which is a same model type as the first device 208-1. In this example, in an instance in which the second sentiment 216-2 from the second device 208-2 is different from the first sentiment 216-1, the processor 102 may determine that the first sentiment 216-1 is unique to the first device 208-1, for instance correlated to the unique identifier of the first device 208-1, or to a user at the first device 208-1, for instance correlated to a user identifier for the user at the first device 208-1.

Continuing with the particular example, the processor 102 may send the second question 224 to two groups of devices 208, a first group including devices 208 that are in the same family as the first device 208-1 and a second group including devices 208 that have the same model processor as the first device 208-1. In a case in which the respective second feedback 212-2 received from the devices 208 in the first group are not the same, for instance, where certain users among the first group of devices 208 have not experienced issues with excessive temperature, the processor 102 may determine that issue correlated with the first sentiment 216-1 is not correlated to all devices 208 in the device family. In another particular example, in a case in which the respective second sentiment 216-2, received from the second group of devices 208 that has the same model processor, are the same as the first sentiment 216-1, for instance, where the users among the second group of devices 208 have experienced similar issues with excessive temperature, the processor 102 may validate the first sentiment 216-1 for all devices 208 in the second group of devices 208 that have the same model processor. In some examples, the processor 102 may validate the first sentiment 216-1 for a certain group of devices 208 when a number of the second feedback 212-2 found to have the same issues as the first feedback 212-1 exceeds a predefined threshold number.

The processor 102 may fetch, decode, and execute the instructions 122 to output information 226 regarding the validation of the determined first sentiment 216-1. In some examples, the processor 102 may update the knowledge base 222 to include the output information 226 regarding the determined topic 214 and the determined first sentiment 216-1 based on the validation of the first sentiment 216-1 correlated to the first device 208-1. In some examples, the processor 102 may output the information 226 to generate a report, a message, to initiate an action, for instance, to open a ticket for a support team for further investigation and/or a fix, and/or the like.

According to examples, the processor 102 may trigger collection of the additional feedback 212 from similar devices 208 based on receipt of the feedback 212. In some examples, the processor 102 may update the knowledge base 222 based on the first feedback 212-1 from the first device 208-1, for instance, as depicted in FIG. 4. The processor 102 may update the knowledge base 222 to include the determined topic 214, the determined first sentiment 216-1, and the device information 218-1 for the first device 208-1. The device information 218-1 may include the characteristic 220-1 of the first device 208-1. In some examples, in response to the update to the knowledge base 222, the processor 102 may determine whether the determined first sentiment 216-1 correlated to the first device 208-1 is a sentiment of interest. The processor 102 may determine whether the determined topic 214 correlated to the first device 208-1 is a topic of interest. Based on a determination that the determined first sentiment 216-1 is a sentiment of interest and/or the determined topic 214 is a topic of interest, the processor 102 may generate the second question 224 based on the determined topic 214 and may send the second question 224 to the second device 208-2.

Referring to FIG. 7, based on receipt of the first feedback 212-1, the processor 102 may initiate the feedback collection process 700 to collect additional feedback 212, such as the second feedback 212-2, to validate the first feedback 212-1. At block 702, the processor 102 may initiate the feedback collection process 700 in response to an update to the knowledge base 222, for instance, based on receipt of the first feedback 212-1 and extraction of information from the first feedback 212-1, as previously described with reference to FIG. 4. At block 704, the processor 102 may determine whether the determined first sentiment 216-1 is a sentiment of interest. At block 706, the processor 102 may fetch the topic 214 correlated to the first feedback 212-1. At block 708, based on a determination that the determined first sentiment 216-1 is a sentiment of interest, the processor 102 may determine whether the determined topic 214 is a topic of interest.

In some examples, the processor 102 may determine whether the first sentiment 216-1 and/or the topic 214 are of interest based on predefined rules. For instance, in a case where negative feedback is of interest, the processor 102 may trigger feedback collection based on topics that map to negative feedback. In some examples, the processor 102 may trigger feedback collection for certain topics, regardless of the associated sentiment. In some examples, the processor 102 may trigger feedback collection for a certain topic when the feedback relates to a certain sentiment.

At block 710, based on a determination that the determined topic 214 is a topic of interest, the processor 102 may receive device information 218-1 for the first device 208-1 from the knowledge base 222. At block 712, the processor 102 may identify a group of similar devices 208 based on the received device information 218-1. In some examples, the group of similar devices 208 may include the second device 208-2. The group of similar devices 208 may be determined based on common characteristics 220 between the first device 208-1 and other devices 208-2 to 208-n. In some examples, multiple groups of similar devices 208 may be identified, for instance, the devices 208 that have the same or similar characteristics as the first device 208-1, including a model type of the first device, a device type of the first device, a device family of the first device, an installed accessory of the first device, a hardware characteristic of the first device, a software characteristic of the first device, and/or the like.

At block 714, the processor 102 may generate one or more than one question correlated to the determined topic 214. In some examples, the one or more than one question may include the second question 224 depicted in FIG. 2. At block 716, the processor 102 may send the generated one or more than one question to the identified group of similar devices 208. Based on a plurality of feedback 212 from the identified group of similar devices 208 in response to the sent one or more than one question, the processor 102 may determine whether the determined first sentiment 216-1 correlated to the determined topic 214 is correlated to the first device 208-1, the identified group of similar devices 208, a subset of the identified group of similar devices 208, and/or the like. At block 718, the processor 102 may determine whether the update to the knowledge base 222 includes another feedback 212 to be processed, and may repeat the process in blocks 704-718 for each additional feedback 212 in the update.

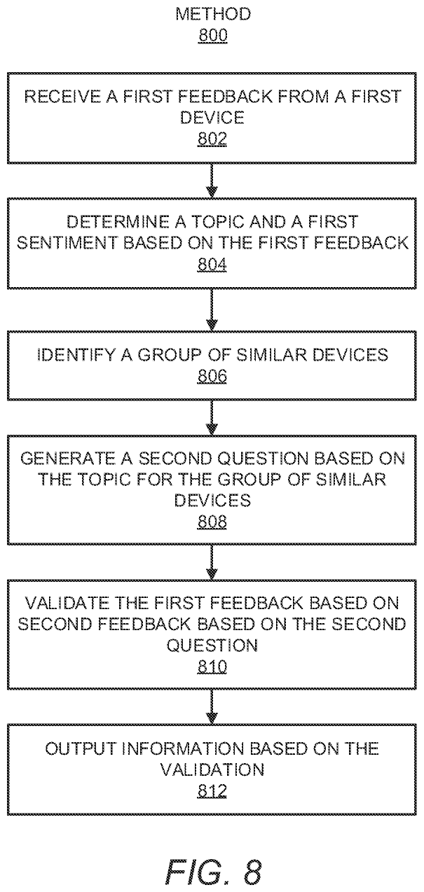

Various manners in which a processor implemented on the apparatus 100 may operate are discussed in greater detail with respect to the method depicted in FIG. 8. FIG. 8 depicts a flow diagram of an example method 800 for determining a topic 214 and a first sentiment 216-1 based on a first feedback 212-1 received from a first device 208-1, and validating the first feedback 212-1 based on a second feedback 212-2 from a second device 208-2. It should be understood that the method 800 depicted in FIG. 8 may include additional operations and that some of the operations described therein may be removed and/or modified without departing from the scope of the method 800. The description of the method 800 is made with reference to the features depicted in FIGS. 1 to 7 for purposes of illustration.

At block 802, the processor 102 may receive the first feedback 212-1 from the first device 208-1. The first feedback 212-1 may be based on the first question 210 output to the first device 208-1. In some examples, the processor 102 may cause a first UI 302 to be displayed at the first device 208-1 to collect the first feedback 212-1. The first UI 302 may include the first question 210 and may include input areas to receive input of the first feedback 212-1.

At block 804, the processor 102 may determine the topic 214 and the first sentiment 216-1 based on the first feedback 212-1. The determined topic 214 and the determined first sentiment 216-1 may be correlated to the first device 208-1. In some examples, the processor 102 extract information from raw feedback data received from the first device 208-1, including the topic 214 and the first sentiment 216-1. The processor 102 may update the knowledge base 222 to save metadata of the extracted information.

At block 806, the processor 102 may identify, based on characteristics 220-1 of the first device 208-1, a group of similar devices, such as the second device 208-2, that have characteristics 220-2 that may be the same as or similar to the characteristics 220-1 of the first device 208-1.

At block 808, the processor 102 may generate the second question 224 based on the determined topic 214. In some examples, the second question 224 may be a follow-up question that is directed to the determined topic 214. In some examples, the second question 224 may be generated to not include the first sentiment 216-1.

At block 810, the processor 102 may validate the determined first sentiment 216-1 correlated to the first device 208-1 based on a plurality of second feedback 212-2 from the identified group of similar devices 208, such as the second device 208-2, responsive to the second question 224.

At block 812, the processor 102 may output information 226 regarding the determined topic 214 and the determined first sentiment 216-1 based on the validation of the determined first sentiment 216-1 correlated to the first device 208-1. In some examples, the processor 102 may output the information 226 to update the knowledge base 222. In some examples, the processor 102 may output the information 226 to generate a report, a message, to initiate an action, for instance, to open a ticket for a support team for further investigation and/or a fix, and/or the like.

In some examples, the processor 102 may determine a second sentiment 216-2 for the determined topic 214 correlated to respective ones of the group of similar devices 208 based on the plurality of second feedback 212-2. The processor 102 may determine whether the determined second sentiment 216-2 correlated to the respective ones of the group of similar devices 208 may be the same as or similar to the determined first sentiment 216-1 correlated to the first device 208-1. Based on a determination that the determined second sentiment 216-2 for the determined topic 214 correlated to respective ones of the group of similar devices 208 may be the same as or similar to the determined first sentiment 216-1, the processor 102 may validate the determined first sentiment 216-1 for the determined topic 214 for the first device 208-1.

In some examples, the processor 102 may, based on the determination that the determined second sentiment 216-2 for the determined topic 214 correlated to respective ones of the group of similar devices 208 may be the same as or similar to the determined first sentiment 216-1, validate the determined first sentiment 216-1 and may correlate the determined first sentiment 216-1 to the group of similar devices 208 having the same or similar characteristics 220 as the characteristic 220-1 of the first device 208-1. In some examples, the characteristics 220-1 of the first device 208-1 may include a user at the first device 208-1, a unique identifier of the first device 208-1, a model type, a device type, a device family, an installed accessory, a hardware characteristic, a software characteristic, and/or the like.

Some or all of the operations set forth in the method 800 may be included as utilities, programs, or subprograms, in any desired computer accessible medium. In addition, the method 800 may be embodied by computer programs, which may exist in a variety of forms both active and inactive. For example, they may exist as machine-readable instructions, including source code, object code, executable code or other formats. Any of the above may be embodied on a non-transitory computer-readable storage medium.

Examples of non-transitory computer-readable storage media include computer system RAM, ROM, EPROM, EEPROM, and magnetic or optical disks or tapes. It is therefore to be understood that any electronic device capable of executing the above-described functions may perform those functions enumerated above.

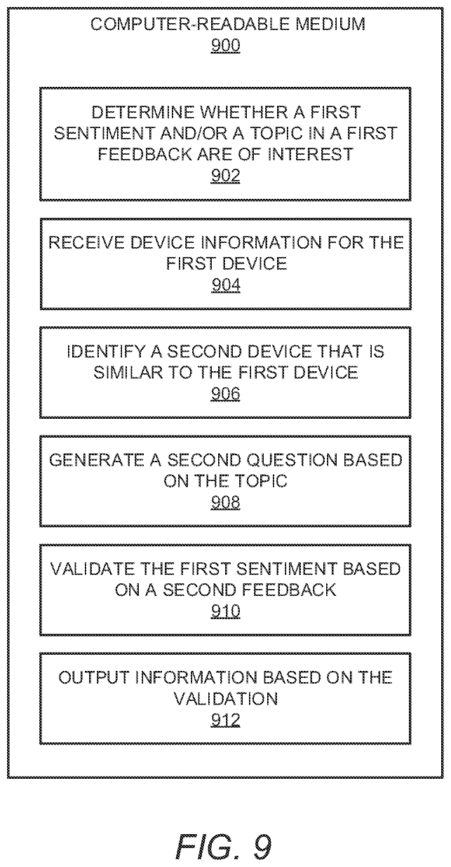

Turning now to FIG. 9, there is shown a block diagram of an example computer-readable medium 900 that may have stored thereon computer-readable instructions to determine whether a first sentiment 216-1 and/or a topic 214 in a first feedback 212-1 are of interest, and based on a determination that the first sentiment 216-1 and/or the topic 214 are of interest, to collect a second feedback 212-2 from a second device 208-2 that is similar to the first device 208-1 to validate the first sentiment 216-1 in the first feedback 212-1. It should be understood that the computer-readable medium 900 depicted in FIG. 9 may include additional instructions and that some of the instructions described herein may be removed and/or modified without departing from the scope of the computer-readable medium 900 disclosed herein. The description of the computer-readable medium 900 is made with reference to the features depicted in FIGS. 1 to 7 for purposes of illustration. The computer-readable medium 900 may be a non-transitory computer-readable medium. The term “non-transitory” does not encompass transitory propagating signals.

The computer-readable medium 900 may have stored thereon machine-readable instructions 902-912 that a processor disposed in an apparatus 100 may execute. The computer-readable medium 900 may be an electronic, magnetic, optical, or other physical storage device that contains or stores executable instructions. The computer-readable medium 900 may be, for example, Random Access memory (RAM), an Electrically Erasable Programmable Read-Only Memory (EEPROM), a storage device, an optical disc, and the like.

The processor may fetch, decode, and execute the instructions 902 to determine, in response to an update in the knowledge base 222 for feedback collection, whether the first sentiment 216-1 and/or the topic 214 in the first feedback 212-1 may be of interest. The first feedback 212-1 may be based on the first question 210 at the first device 208-1

The processor may fetch, decode, and execute the instructions 904 to receive, based on a determination that the determined first sentiment 216-1 and/or the determined topic 214 are of interest, device information 218-1 for the first device 208-1 from the knowledge base 222.

The processor may fetch, decode, and execute the instructions 906 to identify, based on the received device information 218-1 for the first device 208-1, a second device 208-2 that may be similar to the first device 208-1. The second device 208-2 may have a characteristic 220-2 that may be the same as or similar to a characteristic 220-1 of the first device 208-1.

The processor may fetch, decode, and execute the instructions 908 to generate the second question 224 based on the determined topic 214. In some examples, the processor may generate the second question 224 as a follow-up question to the first question 210, which may be directed to the topic 214, while not referring to or including the first sentiment 216-1.

The processor may fetch, decode, and execute the instructions 910 to validate the determined first sentiment 216-1 correlated to the first device 208-1 based on the second feedback 212-2 from the second device 208-2 responsive to the second question 224. In some examples, the processor may validate the first sentiment 216-1 based on a plurality of the second feedback 212-2 from a group of similar devices 208, which may include the second device 208-2.

The processor may fetch, decode, and execute the instructions 912 to output information 226 regarding the determined topic 214 and the determined first sentiment 216-1 based on the validation of the determined first sentiment 216-1 correlated to the first device 208-1. In some examples, the processor 102 may output the information 226 to update the knowledge base 222. In some examples, the processor 102 may output the information 226 to generate a report, a message, to initiate an action, for instance, to open a ticket for a support team for further investigation and/or a fix, and/or the like.

In some examples, the processor may determine a second sentiment 216-2 for the determined topic 214 correlated to the second device 208-2 based on the second feedback 212-2. The processor may determine whether the determined second sentiment 216-2 correlated to the second device 208-2 may be the same as or similar to the determined first sentiment 216-1 correlated to the first device 208-1. In some examples, based on a determination that the determined second sentiment 216-2 correlated to the second device 208-2 may be the same as or similar to the determined first sentiment 216-1 correlated to the first device 208-1, the processor may validate the determined first sentiment 216-1 for the determined topic 214 correlated to the first device 208-1.

In some examples, the processor may validate, based on the determination that the determined second sentiment 216-2 for the determined topic 214 correlated to the second device 208-2 may be the same as or similar to the determined first sentiment 216-1 correlated to the first device 208-1, the determined first sentiment 216-1 and may correlate the determined first sentiment 216-1 to a group of similar devices 208, which may have the same or similar characteristic 220 as the first device 208-1 and the second device 208-2.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine-readable instructions that when executed by the processor, cause the processor to:
receive a first feedback from a first device in response to a first question;
determine a topic and a first sentiment based on the first feedback, the first feedback being correlated to the first device;
identify a second device having a characteristic that is the same as a characteristic of the first device;
generate a second question based on the determined topic;
validate the determined first sentiment based on a second feedback from the second device responsive to the second question; and
output information regarding the validation of the determined first sentiment.

2. The apparatus of claim 1, wherein the instructions further cause the processor to:
determine the characteristic of the first device based on device information included in the first feedback, wherein the determined characteristic of the first device comprises:
a user at the first device, a unique identifier, a model type, a device type, a device family, an installed accessory, a hardware characteristic, a software characteristic, or a combination thereof.

3. The apparatus of claim 1, wherein the instructions further cause the processor to:
receive the second feedback from the second device;
determine a second sentiment correlated to the determined topic based on the second feedback; and
determine whether the second sentiment from the second device correlates to the determined first sentiment from the first device.

4. The apparatus of claim 3, wherein the instructions further cause the processor to:
based on a determination that the second sentiment from the second device correlates to the determined first sentiment from the first device, validate the determined first sentiment correlated to the determined topic from the first device.

5. The apparatus of claim 3, wherein the instructions further cause the processor to:
based on the determination that the second sentiment from the second device correlates to the determined first sentiment from the first device, validate the determined first sentiment as being correlated to the determined topic for:
a user at the first device, a unique identifier of the first device, a model type of the first device, a device type of the first device, a device family of the first device, an installed accessory of the first device, a hardware characteristic of the first device, a software characteristic of the first device, or a combination thereof.

6. The apparatus of claim 1, wherein the instructions further cause the processor to:
determine a second sentiment for the determined topic correlated to the second device based on the second feedback;
determine whether the determined second sentiment correlated to the second device is the same as the determined first sentiment correlated to the first device; and
based on a determination that the determined second sentiment is the same as the determined first sentiment, validate the determined first sentiment for the determined topic for the first device.

7. The apparatus of claim 6, wherein the instructions further cause the processor to:
based on the determination that the determined second sentiment is the same as the determined first sentiment, validate the determined first sentiment and correlate the determined first sentiment to a plurality of devices having the same characteristic as the first device and the second device.

8. The apparatus of claim 1, wherein the instructions further cause the processor to:
update a knowledge base based on the first feedback from the first device, the update including the determined topic, the determined first sentiment, and device information for the first device, the device information including the characteristic of the first device;
in response to the update to the knowledge base:
determine whether the determined first sentiment correlated to the first device is a sentiment of interest;
determine whether the determined topic correlated to the first device is a topic of interest;
based on a determination that the determined first sentiment is a sentiment of interest and/or the determined topic is a topic of interest, generate the second question based on the determined topic; and
send the second question to the second device.

9. The apparatus of claim 1, wherein the instructions further cause the processor to:
determine whether the determined first sentiment is a sentiment of interest;
based on a determination that the determined first sentiment is a sentiment of interest, determine whether the determined topic is a topic of interest;
based on a determination that the determined topic is a topic of interest, receive device information for the first device from a knowledge base;
identify a group of similar devices based on the received device information, the group of similar devices including the second device;
generate one or more than one question correlated to the determined topic, the one or more than one question including the second question;
send the generated one or more than one question to the identified group of similar devices; and
based on a plurality of feedback from the identified group of similar devices in response to the sent one or more than one question, determine whether the determined first sentiment correlated to the determined topic is correlated to the first device, the identified group of similar devices, a subset of the identified group of similar devices, or a combination thereof.

10. A method comprising:
receiving, by a processor, a first feedback from a first device, the first feedback being based on a first question output to the first device;
determining, by the processor, a topic and a first sentiment based on the first feedback, the determined topic and the determined first sentiment being correlated to the first device;
based on characteristics of the first device, identifying, by the processor, a group of similar devices that have characteristics that are the same as the characteristics of the first device;
generating, by the processor, a second question based on the determined topic;
validating, by the processor, the determined first sentiment correlated to the first device based on a plurality of second feedback from the identified group of similar devices responsive to the second question; and
outputting, by the processor, information regarding the determined topic and the determined first sentiment based on the validation of the determined first sentiment correlated to the first device.

11. The method of claim 10, further comprising:
determining a second sentiment for the determined topic correlated to respective ones of the group of similar devices based on the plurality of second feedback;
determining whether the determined second sentiment correlated to the respective ones of the group of similar devices is the same as the determined first sentiment correlated to the first device; and
based on a determination that the determined second sentiment for the determined topic correlated to respective ones of the group of similar devices is the same as the determined first sentiment, validating the determined first sentiment for the determined topic for the first device.

12. The method of claim 11, further comprising:
based on the determination that the determined second sentiment for the determined topic correlated to respective ones of the group of similar devices is the same as the determined first sentiment, validating the determined first sentiment and correlating the determined first sentiment to the group of similar devices having the same characteristics as the first device, the characteristics of the first device including a user at the first device, a unique identifier, a model type, a device type, a device family, an installed accessory, a hardware characteristic, a software characteristic, and/or the like.

13. A non-transitory computer-readable medium on which is stored machine-readable instructions that when executed by a processor, cause the processor to:
in response to an update in a knowledge base for feedback collection, determine whether a first sentiment and/or a topic in a first feedback are of interest, the first feedback being based on a first question at a first device;
based on a determination that the determined first sentiment and/or the determined topic are of interest, receive device information for the first device from the knowledge base;
based on the received device information for the first device, identify a second device that is similar to the first device, the second device having a characteristic that is the same as a characteristic of the first device;
generate a second question based on the determined topic;
validate the determined first sentiment correlated to the first device based on a second feedback from the second device responsive to the second question; and
output information regarding the determined topic and the determined first sentiment based on the validation of the determined first sentiment correlated to the first device.

14. The non-transitory computer-readable medium of claim 13, wherein the instructions cause the processor to:
determine a second sentiment for the determined topic correlated to the second device based on the second feedback;
determine whether the determined second sentiment correlated to the second device is the same as the determined first sentiment correlated to the first device; and
based on a determination that the determined second sentiment correlated to the second device is the same as the determined first sentiment correlated to the first device, validate the determined first sentiment for the determined topic correlated to the first device.

15. The non-transitory computer-readable medium of claim 14, wherein the instructions cause the processor to:
based on the determination that the determined second sentiment for the determined topic correlated to the second device is the same as the determined first sentiment correlated to the first device, validate the determined first sentiment and correlate the determined first sentiment to a group of similar devices having the same characteristic as the first device and the second device.
